(19) United States
(12) Patent Application Publication
(10) Pub. No.: US 2025/0273314 A1
(43) Pub. Date: Aug. 28, 2025

(54) MEDICATION INVENTORY MANAGEMENT SYSTEM

(71) Applicant: CareFusion 303, Inc., San Diego, CA (US)

(72) Inventor: Shannon John Johnson, San Diego, CA (US)

(21) Appl. No.: 18/857,421

(22) PCT Filed: Apr. 20, 2022
(86) PCT No.: PCT/US2022/025627

§ 371 Date: Oct. 16, 2024

(51) Int. Cl. G16H 20/10; G06Q 10/087; G16H 40/20

(52) U.S. Cl. CPC G16H 20/10; G06Q 10/087; G16H 40/20

(57) ABSTRACT

A method for adjusting a medical device within the medical facility to conserve usage of the medication is provided. The method may include receiving, from a medication inventory system, medication inventory data comprising an ordered quantity of a medication ordered to supply a medical facility and a received quantity of the medication delivered to the medical facility. The method may also include generating, based on the medication inventory data, a medication inventory metric, which indicates a likelihood of an interruption in supply of the medication to the medical facility. The method may also include adjusting, based on the medication inventory metric, a medical device within the medical facility to conserve usage of the medication. Related methods and articles of manufacture are also disclosed.

### TECHNICAL FIELD

The subject matter described herein relates to managing systems for medication inventory, and more particularly, to a management system that detects likelihoods of interruptions in the supply of medication.

### BACKGROUND

Institutional pharmacies and medical facilities regularly order medication to supply the pharmacies and medical facilities, and to ensure that the medication needed to treat patients is available. When ordering medication, pharmacists, caregivers, or prescribers often manually review purchasing and inventory management reports. However, such reports are generally rearward-looking and may lack information about availability and any pre-existing medication shortages. Thus, the medical professionals are left unable to plan for or anticipate current or future medication shortages, making it difficult for the medical professionals to appropriately allocate and conserve usage of the medication. Furthermore, current systems and devices cannot detect and respond to supply fluctuations. Such circumstances can also be harmful for patients, as the appropriate medication may be delayed or unavailable due to unforeseen shortages of the medication.

### SUMMARY

According to some aspects, a method may include receiving, from a medication inventory system, medication inventory data that includes an ordered quantity of a medication ordered to supply a medical facility and a received quantity of the medication delivered to the medical facility. The medication inventory data may be received after receipt of the received quantity by the medical facility. The method may also include generating, based on the medication inventory data, a medication inventory metric. The medication inventory metric may indicate a likelihood of an interruption in supply of the medication to the medical facility. The method may also include adjusting, based on the medication inventory metric, a medical device within the medical facility to conserve usage of the medication.

In some aspects of the method, the adjusting includes transmitting an alert indicating the likelihood of the interruption in the supply of the medication to the medical facility.

In some aspects of the method, the alert includes one or more of a recommended action at a medication dispenser associated with the medical facility, a request for selection of an alternative medication that is different from the medication ordered at the medical facility, a display of an inventory level of the medication at the medical facility, a display of a historical usage of the medication at the medical facility, a display of an inventory level of the alternative medication at the medical facility, and a display of a second medication inventory metric associated with the alternative medication.

In some aspects of the method, the recommended action includes moving at least a portion of the medication stored at the medication dispenser to a second medication dispenser.

In some aspects of the method, a second clinical need of the medication at the second medication dispenser is greater than a first clinical need of the medication at the medication dispenser.

In some aspects of the method, generating the inventory metric includes determining a difference between the ordered quantity and the received quantity.

In some aspects of the method, the medication inventory metric is a confidence level that indicates the likelihood of the interruption in the supply of the medication to the medical facility.

In some aspects, the method also includes determining, based on the medication inventory metric corresponding to a threshold, the likelihood of the interruption in supply of the medication is a significant likelihood.

In some aspects, the method also includes determining, based on the medication inventory metric corresponding to a second threshold, a shortage of the medication.

In some aspects, the method also includes detecting, prior to generating the medication inventory metric, a measure of statistical significance as compared to the medication inventory data at the medication inventory system. The generating may be in response to the detecting.

In some aspects, the method may also include detecting receipt of the received quantity at the medication inventory system.

In some aspects, the method also includes receiving, from the medication inventory system, updated medication inventory data including another ordered quantity of the medication ordered to supply the medical facility and another received quantity of the medication at the medical facility. The updated medication inventory data may be received after receipt of the another received quantity by the medical facility. The method may also include adjusting, based on the updated medication inventory data, the medication inventory metric.

In some aspects, the method includes displaying, based on the adjusted medication inventory metric, a graphical element on a display. The graphical element may indicate a change in the likelihood of the interruption in the supply of the medication to the medical facility.

In some aspects, the method also includes adjusting, based on the medication inventory metric, a protocol for handling the medication identified as having a supply interruption or shortage.

In some aspects, the method also includes detecting a request to access a medication dispenser to retrieve the medication identified as having a supply interruption or shortage. The method may further include requiring, based on the adjusting, one or more of a witness during the access of the medication dispenser and an enhanced authentication or logging to access the medication from the medication dispenser.

In some aspects, the method also includes identifying, based on the medication inventory metric, a shortage of the medication.

In some aspects of the method, the medical facility includes a plurality of medical facilities.

In some aspects of the method, the medical facility is a first medical facility located in a first geographical region. The medication inventory data may be a first subset of inventory data associated with the first medical facility. The medication inventory metric may be a first medication inventory metric that indicates a likelihood of an interruption in supply of the medication to the first medical facility. The method may further include receiving, from the medication inventory system, a second subset of medication inventory data including a second ordered quantity of the medication ordered to supply a second medical facility located in a second geographical region and a second received quantity of the medication at the second medical facility. The second subset of the medication inventory data may be received after receipt of the second received quantity by the second medical facility. The method may also include generating, based on the second subset of the medication inventory data, a second medication inventory metric. The second medication inventory metric may indicate a likelihood of an interruption in supply of the medication to the second medical facility.

In some aspects, the method includes comparing the first medication inventory metric to the second medication inventory metric.

In some aspects, the method also includes detecting, based on the comparing, a trend in the likelihood of the interruption in supply of the medication.

Implementations of the current subject matter can include methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the management of medication inventory, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a block diagram illustrating a medication inventory management system, in accordance with some example implementations;

FIG. 2 schematically depicts an example medication inventory management system, in accordance with some example implementations;

FIG. 3 depicts a system diagram illustrating an example of a medication inventory management system, in accordance with some example implementations;

FIG. 4 depicts a flowchart illustrating a process for conserving usage of medication within a medical facility, in accordance with some example implementations; and

FIG. 5 depicts a block diagram illustrating a computing system, in accordance with some example implementations.

When practical, similar reference numbers denote similar structures, features, or elements.

### DETAILED DESCRIPTION

Institutional pharmacies and medical facilities regularly order medication to supply the pharmacies and medical facilities, and to ensure that the medication needed to treat patients is available. Reports tracking the inventory of medication can be generated and provided to the medical professionals (e.g., pharmacists, caregivers, etc.). However, such medical professionals often need to manually review the reports to determine whether the medication is available. Such reports are generally rearward-looking, either providing information about pre-existing medication shortages or providing out of date information. This leaves medical professionals an inadequate amount of time to plan for or adapt to the medication shortages. By relying on such reports, medical professionals may also be left to make highly subjective and often inaccurate conclusions about possible medication shortages. In both instances, medical professionals are left unable to appropriately allocate and conserve usage of the medication. Furthermore, current systems and devices cannot detect and respond to supply fluctuations. Such circumstances can be harmful for patients, as the appropriate medication may not be available due to unforeseen shortages of the medication.

The medication inventory management system described herein may provide a broad level of useful analytics that help to improve tracking and predicting potential or actual medication shortages. Thus, the medication inventory management system desirably helps medical professionals including medication prescribers to conserve usage of the medication and proactively adapt to possible medication shortages. For example, the medication inventory management system may, in real time, detect a potential or actual shortage of a medication, dynamically make adjustments, such as at medication dispensers, and/or recommend mitigation strategies to allocate and conserve the medication that may be in short supply. As used herein, “real-time” or “real time” may refer to availability for processing at or near in time to the time the associated item is generated or detected or otherwise available. The medication inventory management system may also improve the accuracy of the predictions of potential or actual shortages of the medication by relying on a large amount of accessible medication inventory data as part of the medication inventory management system. The medication inventory management system may also provide prescribers with information and other tools for quickly and proactively adjusting clinical and prescribing practices to adapt to potential or likely interruptions in the supply of the medication. The medication inventory management system may also help to reduce diversion of medication that has been indicated as having a high likelihood of being in limited supply.

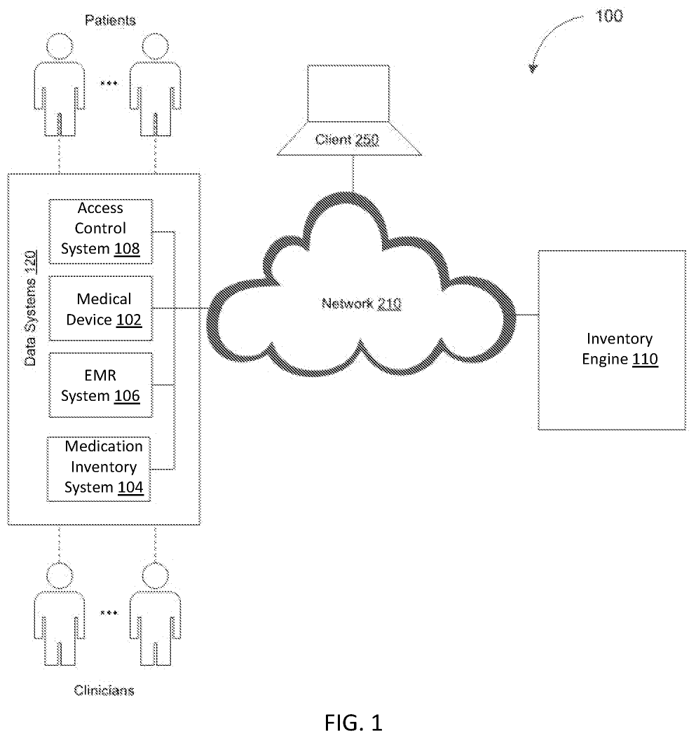

FIG. 1 depicts a system diagram illustrating an example of a medication inventory management system 100, consistent with implementations of the current subject matter. As shown in FIG. 1, the medication inventory management system 100 may include one or more data systems 120, a client 250, and an inventory engine 110.

The inventory engine 110, the client 250, and the one or more data systems 120 may be communicatively coupled via a network 210. The client 250 may be a processor-based device such as, for example, a smartphone, a tablet computer, a wearable apparatus, a desktop computer, a laptop computer, a workstation, and/or the like. The client 250, which may display one or more generated medication inventory metrics and/or visualizations, may form a part of or be separately coupled to the one or more data systems, such as the dispensing system 102. The network 210 may be any wired and/or wireless network including, for example, a public land mobile network (PLMN), a local area network (LAN), a virtual local area network (VLAN), a wide area network (WAN), the Internet, and/or the like.

Referring to FIG. 1, the one or more data systems 120 may include an access control system 108, a medical device 102, an electronic medical record (EMR) system 106, a medication inventory system 104, or the like.

The medical device 102 may be separately coupled to and/or include the inventory engine 110. In some implementations, the inventory engine 110 includes a processor and memory for storing instructions, which when executed by the processor, performs one or more operations described herein.

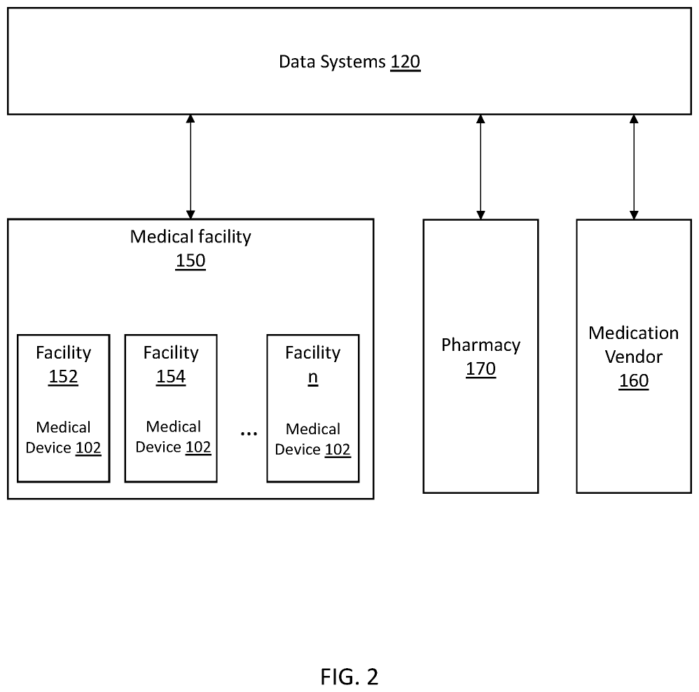

The medical device 102 may be located within a medical facility 150 and/or a pharmacy 170 (see FIG. 2). The medical device 102 may include a dispenser system, such as a medication dispenser or dispensing station, an automated dispensing cabinet, an anesthesia station, or the like, to store medications and deliver medications as they are needed to treat patients. The medical device 102 (e.g., the dispenser system) may thus provide convenient access to medication for caregivers in patient care areas. For example, a separate dispenser system may be positioned within each patient care area of a medical facility to supply the medication to each corresponding patient care area. Each patient care area may be used for treating different a different patient or different groups of patients. As a result, there may be a varying clinical need in each patient care area for a particular medication. To conserve the particular medication, the inventory engine 110 (as described in more detail below) may accurately and efficiently predict a likelihood of an interruption in the supply of the medication. The inventory engine 110 may additionally or alternatively recommend moving the medication from one patient care area to another and/or may inform caregivers to better help the caregivers making decisions as to where the medication should be moved based on clinical need. The medical device 102 may additionally or alternatively include an infusion pump, a wasting station, or the like.

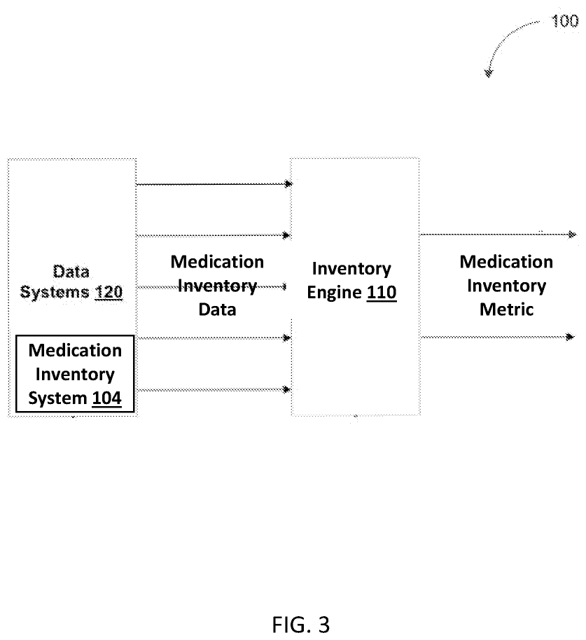

As described above, the medical device 102 may be positioned within the medical facility 150 and/or the pharmacy 170. As an example, FIG. 3 schematically illustrates the medication inventory management system 100, consistent with implementations of the current subject matter. Referring to FIG. 3, the medication inventory management system 100 may include the medical facility 150, the pharmacy 170, and a medication vendor 160. The medical facility 150, the pharmacy 170, and the medication vendor 160 may be communicatively coupled with one another. The medical facility 150, the pharmacy 170, and the medication vendor 160 may additionally or alternatively be communicatively coupled with the one or more data systems 120, the client 250, and/or the inventory engine 110.

The medical facility 150 may include at least one facility, such as a first facility 152, a second facility 154, another facility n, and so on. The medical facilities 150 may each be located within a same or different geographical region, such as within the same or different zip code, city, country, or the like. The pharmacy 170 may form a part of and/or be separate from the medical facility 150. In some instances, the medical facility 150 may additionally or alternatively include one or more pharmacies 170, such as one, two, three, four, five, ten or more pharmacies 170. The pharmacy 170 may include one, two, three, four, five, one hundred, one thousand, or more pharmacies. The medication vendor 160 may include one or more medication distributors, wholesalers, manufacturers, or the like, from which the medical facility 150 and/or the pharmacy 170 can obtain the medication. The medication vendor 160 may include one, two, three, four, five, one hundred, one thousand, or more medication vendors 160.

A pharmacist at the pharmacy 170 may submit a purchase order including an ordered quantity of a medication to supply either the pharmacy, to fulfill a particular order, and/or to supply the medical facility 150. As another example, a medical professional at the medical facility 150 may submit a purchase order including an ordered quantity of a medication to supply at least a portion of the medical facility 150. The purchase order including the ordered quantity of the medication may be transmitted, as part of an order message, to the medication vendor 160 to fulfill the purchase order. At the medication vendor 160, the order message may be received. The medication vendor may then, in some instances, provide a delivered quantity of the medication to the corresponding medical facility 150 and/or pharmacy 170. Fulfillment (e.g., total fulfillment, partial fulfillment, and the like) may trigger generation of a delivery message, such as an invoice, advanced shipping notice, an inventory event (e.g., a pharmacy or medical facility stocking the medication), or the like.

In some instances, the medication vendor 160 may partially fulfill the purchase order. In other words, the medication vendor 160 may supply the medical facility 150 and/or the pharmacy 170 with a quantity of the medication that is an allocation (e.g., only a portion) of the order quantity of the medication included in the purchase order. Such instances may indicate a likelihood of an interruption in the supply of the medication, such as a shortage. In other instances, the medication vendor 160 may not fulfill the purchase order. In other words, the received quantity may not include any medication such that the medication vendor 160 may not supply the medical facility 150 and/or the pharmacy 170 with any of the ordered quantity of the medication. Such instances may indicate a significant likelihood of an interruption in the supply of the medication, such as a shortage. Based on the ordered quantity and/or the delivered quantity, the inventory engine 110 may generate an inventory metric indicating the likelihood of the interruption in the supply of the medication.

Referring again to FIG. 2, the ordered quantity of the medication and the received or delivered quantity of the medication may be stored at the data systems 120, such as at the medication inventory system 104, as medication inventory data. The medication inventory data may, in some implementations, be an inference of a wholesalers inventory. For example, as described herein the medication inventory data may be used to infer a possible shortage or other interruption in supply of the medication based on the ordered quantity of the medication and/or the received or delivered quantity of the medication.

In some implementations, the ordered quantity of the medication and the received or delivered quantity of the medication are extracted, such as by the inventory engine 110, from the order message and/or the delivery message and/or inbound order processing and stored at the medication inventory system 104. The medication inventory system 104 may include a database or other data store for storing the ordered quantity of the medication and the received quantity of the medication.

In some implementations, the medication inventory system 104 may additionally store medication inventory data including metadata corresponding to the ordered quantity of the medication. The metadata corresponding to the ordered quantity may include a timestamp of the purchase order, an identifier associated with the medical professional submitting the purchase order, an identifier associated with the medical facility 150 and/or the pharmacy 170, an identifier associated with the medication vendor 160 to which the purchase order was transmitted, medication information associated with the medication, and the like. The metadata corresponding to the ordered quantity of the medication may be generated when the purchase order is submitted.

In some implementations, the medication inventory system 104 may also store medication inventory data including metadata corresponding to the received quantity of the medication. The metadata corresponding to the received quantity may include a timestamp of receipt of the purchase order, the identifier associated with the medical professional submitting the purchase order, the identifier associated with the medical facility 150 and/or the pharmacy 170, the identifier associated with the medication vendor 160, medication information associated with the medication, invoice information associated with the issued invoice, and the like. The metadata corresponding to the delivered quantity of the medication may be generated when the purchase order is received by the medication vendor 160, when the purchase order is fulfilled, when the medication is delivered to the medical facility 150 and/or the pharmacy, when the medication is received or stocked at the medical facility 150 and/or the pharmacy 170, or the like. The medication inventory data may thus be used to track and compare the ordered quantity of the medication to the received quantity of the medication.

Referring again to FIG. 2, the medication inventory management system 100 may include the medical facility 150. The medical facility 150 may be a hospital, patient treatment facility, or the like. The medical facility 150 may include or be separate from a patient care area, a medical device, a medication dispenser, the pharmacy 170, or the like. The medical facility 150 may include a plurality of medical facilities 150 such that the medication inventory system 104 receives and stores medication inventory data associated with the plurality of medical facilities 150.

In some instances, the medication inventory system 104 is communicatively coupled with a significant number of medical facilities. For example, the medication inventory system 104 may be communicatively coupled with tens, hundreds, thousands, or a greater number of medical facilities. As such, the medication inventory system 104 may store or have access to a quantity of medication inventory data that achieves statistical significance in support of the predictions generated thereby. For example, the statistically significant quantity of the medication inventory data can be represented by a measure of statistical significance as compared to the medication inventory data stored at the medication inventory system 104. The measure of statistical significance can be a p-value, such as a p-value being less than 0.05. In some implementations, the measure of statistical significance represents that a statistically significant quantity of the medication inventory data has been reached within a period of time (e.g., 24 hours, one week, one month, one year, or the like).

Since, the medication inventory system 104 is communicatively coupled with a large number of medical facilities 150, the medication inventory system 104 may quickly achieve the statistically significant quantity of stored medication inventory data. Relying on a statistically significant quantity of the stored medication inventory data quickly and efficiently improves the accuracy of predictions made by the inventory engine 110, improves the accuracy of metrics generated by the inventory engine 110, improves the speed of the inventory engine 110 in making adjustments based on the predictions or metrics, or the like. Such arrangements may also allow for the medication inventory system 104 to achieve statistical significance more quickly than other systems, allowing for subsequent changes in the ordering of the medication to be made more quickly, increasing the confidence in the predictions made by the inventory engine 110, or the like.

FIG. 3 schematically depicts a system diagram illustrating the medication inventory management system 100, in accordance with some example implementations. Referring to FIG. 3, the inventory engine 110 may be communicatively coupled with the one or more data systems 120. The inventory engine 110 may receive, from the one or more data systems 120, such as the medication inventory system 104, the medication inventory data. Based on the medication inventory data, the inventory engine 110 may generate an inventory metric indicating a likelihood of an interruption in supply of the medication to the medical facility. While in some instances, the methods and systems are described with respect to the medical facility, the methods and systems may also apply to a pharmacy, such as the pharmacy 170.

In some implementations, the inventory engine 110 may detect, prior to generating the medication inventory metric, the measure of statistical significance as compared to the medication inventory data stored at the medication inventory system 104. The inventory engine 110 may generate the inventory metric in respond to detecting the measure of statistical significance.

The inventory metric may include a score, a classifier (e.g., good signal, good performance, weak signal, poor performance, etc.), or the like. The inventory engine 110 may determine the inventory metric by comparing the ordered quantity of the medication and the received (e.g., delivered to the facility) quantity of the medication corresponding to the ordered quantity. The received quantity may correspond to the ordered quantity when the received quantity and the ordered quantity are associated with a same purchase order, a same transaction, share at least a portion of the metadata, and/or the like. By comparing the received quantity to the ordered quantity, the inventory engine 110 may determine a difference between the ordered quantity and the received quantity. If the received quantity is less than the ordered quantity, the inventory engine 110 may detect a likelihood of an interruption in supply of the medication. For example, the difference between the ordered quantity and the received quantity may indicate an inability to supply the medication, and represent a new or existing shortage of the medication.

In some implementations, the inventory engine 110 may generate the medication inventory metric using machine learning techniques. A model may be implemented as a machine learning model to generate the medication inventory metric. For example, the model may be trained to accept a variety of factors as inputs, such as the difference between the ordered quantity and the received quantity, a timestamp associated with the ordered quantity and/or the received quantity, a time of year associated with the medication inventory data, a demand for therapeutic substitutions (e.g., different medications used to treat a same condition), supply of raw goods, weather conditions, and/or the like. The model may provide, as an output, the medication inventory metric, including a value or set of values indicating the likelihood of the interruption in the supply of the medication. The medication inventory metric may be accompanied by a confidence value indicating how likely the medication inventory metric is associated with the corresponding classification (e.g., the likelihood of interruption in the supply of the medication). The confidence value may be used by a device to determine whether the medication inventory metric is reliable or sufficiently certain to take action. The reliability or sufficiency may be assessed based on the confidence value corresponding to a threshold value or value range.

The learning may be supervised, unsupervised, reinforced, or a hybrid learning whereby multiple learning techniques are employed to generate the model. The learning may be performed as part of training. Training the model may include obtaining a set of training data and adjusting characteristics of the model to obtain a desired model output. For example, three characteristics may be associated with the generation of the medication inventory metric. In such instance, the training may include receiving the three characteristics as inputs to the model and adjusting the characteristics of the model such that for each set of three characteristics, the output inventory metric corresponds to a likelihood of the interruption in the supply of the medication to the medical facility. In this way, the model can output a value (e.g., the medication inventory metric) associated with the status of the likelihood of the interruption in the supply of the medication to the medical facility.

In some implementations, the training may be dynamic. For example, the system may update the model using a set of events. The detectable properties from the events may be used to adjust the model.

The model may be an equation, artificial neural network, recurrent neural network, convolutional neural network, decision tree, or other machine-readable artificial intelligence structure. The characteristics of the structure available for adjusting during training may vary based on the model selected. For example, if a neural network is the selected model, characteristics may include input elements, network layers, node density, node activation thresholds, weights between nodes, input or output value weights, or the like. If the model is implemented as an equation (e.g., regression), the characteristics may include weights for the input parameters, thresholds or limits for evaluating an output value, or criterion for selecting from a set of equations.

Once a model is trained, retraining may be included to refine or update the model to reflect additional data or specific operational conditions. The retraining may be based on one or more transactions detected by a device described herein or as part of a method described herein. For example, a threshold indicating the likelihood of the interruption in the supply of the medication to the medical facility may be defined whereby after a threshold quantity of medication inventory data is obtained and/or a threshold quantity of medication inventory metrics are obtained, sufficient data is available to retrain the model. In some implementations, the retraining may be periodic, based on an elapsed time since the model was previously trained. Upon detection of the designated transactions, the system may activate a training process to adjust the model as described.

Further examples of machine learning and modeling features which may be included in the embodiments discussed above are described in “A survey of machine learning for big data processing” by Qiu et al. in EURASIP Journal on Advances in Signal Processing (2016) which is hereby incorporated by reference in its entirety.

In some implementations, the medication inventory metric is a confidence level indicating the likelihood of the interruption in the supply of the medication to the medical facility. The inventory engine 110 may identify a shortage or potential shortage of the medication based on the medication inventory metric (e.g., the confidence level).

The inventory engine may determine the likelihood of the interruption (e.g., an allocation, at least a portion of the ordered medication is delivered, etc.) in delivery of the medication is a significant likelihood based on the medication inventory metric corresponding to a threshold (e.g., a first threshold). Additionally or alternatively, the inventory engine may determine a shortage (e.g., none of the ordered medication is delivered, a minimal amount of the ordered medication is received, etc.) of the medication based on the medication inventory metric corresponding to a second threshold. The first threshold and the second threshold may be scaled. The first threshold and the second threshold may be represented by a p-value. The first threshold and the second threshold may be represented by a single p-value and/or a range of p-values. For example, the first threshold may include a p-value of 0.05 to 0.1. Thus, the inventory engine 110 may determine that there is the interruption when the medication inventory metric corresponds to the p-value of 0.05 to 0.1. The second threshold may include a p-value of less than 0.05. Thus, the inventory engine 110 may determine that there is the shortage when the medication inventory metric corresponds to the p-value of less than 0.05.

The first threshold and the second threshold may be adjusted, such as by the medical facility. For example, the medical facility 150 may adjust the first threshold and/or the second threshold based on the tolerance of the medical facility 150 for shortages in the medication. The tolerance may depend on a number of factors, including a need for the medication, a size of the medical facility, a location of the medical facility, or the like.

As user herein, the terms “correspond” or “corresponding” encompasses a structural, functional, quantitative and/or qualitative correlation or relationship between two or more objects, data sets, information and/or the like, preferably where the correspondence or relationship may be used to translate one or more of the two or more objects, data sets, information and/or the like so to appear to be the same or equal. Correspondence may be assessed using one or more of a threshold, a value range, fuzzy logic, pattern matching, a machine learning assessment model, or combinations thereof.

The thresholds, such as the first threshold and/or the second threshold, described may be static, dynamic, or adaptive. Static thresholds are predetermined thresholds that remain constant. Dynamic thresholds are changed throughout operation of the system based on changes to the system or items stored therein. For example, as the need for the medication increases, it may be desirable to adjust the first threshold or the second threshold. A dynamic threshold may be based on a number of factors, including a need for the medication, a size of the medical facility, a location of the medical facility, or the like. A dynamic threshold may be based on time or date. For example, there may be times when there are fewer medication orders requested within an environment. Adaptive thresholds may be changed in response to changes in characteristics of the medical devices and/or items stored therein and may vary depending parameters detectable or received by the system. Whether static, dynamic, or adaptive, the threshold may be specified as a value or a range of values.

The generated medication inventory metric may be stored at the medication inventory system 104. The medication inventory metric may be associated with the corresponding purchase order within the medication inventory system 104. This allows for the inventory engine 110 to predict a trend in the inventory metric over time, display a visualization indicating the trend, compare the inventory metric over time (e.g., beginning of a month, middle of a month, end of a month, etc.). This may also allow for the inventory engine 110 to compare the inventory metric across different geographical regions.

Based on the medication inventory metric, the inventory engine 110 may adjust the medical device 102 within the medical facility to conserve usage of the medication.

In some implementations, the inventory engine 110 may transmit an alert (e.g., visual, audio, audiovisual, or the like) indicating the likelihood of the interruption in the supply of the medication to the medical facility. The alert may be displayed at the medical device 102, such as at a display of the medical device (e.g., the dispenser system), at a display coupled to a clinician prescribing system, and/or the like. The alert may include one or more of a recommended action at a medication dispenser associated with the medical facility, a request for selection of an alternative medication that is different from the medication ordered at the medical facility, a display of an inventory level of the medication at the medical facility, a display of a historical usage of the medication at the medical facility, a display of an inventory level of the alternative medication at the medical facility, and a display of a second medication inventory metric associated with the alternative medication.

For example, the alert may include a recommended action at a medication dispenser. The recommended action may include moving at least a portion of the medication stored at the medication dispenser to a second medication dispenser. The second dispenser may be positioned within a different patient care area than the first medication dispenser. In some implementations, the clinical need of the medication may be greater at the second medication dispenser than the first medication dispenser. The clinical need may be greater where the sickest patients are located, and/or may be determined by a clinician. In some implementations, the alert includes information with respect to the likelihood of the interruption of the supply of the medication to inform the clinician and/or to enable the clinician to determine where to move at least the portion of the medication.

In some implementations, the inventory engine 110 can detect that multiple clinicians from multiple patient care areas are in need of the medication that has been identified as potentially being in low supply (e.g., the likelihood of interruption in the supply). The inventory engine 110 may arbitrate the requests and recommend allocations of the medication where the clinical need is the highest or provide information for the clinicians to determine where the clinical need is the highest. The clinical need described herein may be based on therapeutic need (e.g., minimize potential of running low for a shortage of medication for high acuity level or certain patient care areas), historical usage, or other criteria specified by policy, medical facility, or pharmacy practice.

In some implementations, the inventory engine 110 may cause display of the alert at the physician ordering system, such as at the medication dispenser, the pharmacy, and/or the like. For example, a visual element (e.g., notification, alert, or the like) may be provided on a display coupled to the physician ordering system. In other words, the alert may be presented to the prescriber as a contextual alert or visual icon at the point of prescribing the medication. This may encourage appropriate therapeutic substitution of the medication affected by the possible shortage or interruption in supply with their therapeutic equivalents that may be more readily available. The medication inventory metric may be used, such as by the inventory engine 110 or by the prescriber, to filter, organize, or otherwise prioritize the presentation of the medication available. The inventory engine 110 may also detect the impact of companion medication, such as a medication that may be commonly administered together or in sequence with the medication that is affected by the possible shortage or interruption in supply. For example, if one of the medications is detected to be affected by the possible shortage or interruption in supply, the inventory engine 110 may provide an indication to select a therapeutic alternative of one or each of the medications of the regimen. This can help to conserve medication resources and reduce the impact of the detected shortage or likelihood of the interruption in the supply of the medication.

In some implementations, the inventory engine 110 may cause display of the medication inventory metric and/or a visual element indicating the likelihood of interruption in the supply of the medication. For example, the inventory engine 110 may cause display via the client 250. In some implementations, the inventory engine 110 causes display of a visualization representing the change in the medication inventory metric over time, compared between different geographic regions, compared between different medications, or the like. In some implementations, the inventory engine 110 generates a report including the medication inventory metric, or the like. The report and/or the visualization may include current inventory levels of the medication, historical usages (e.g., averages), a number of active patient orders of the medication, or the like. This allows for clinicians to react quickly to possible or likely interruptions in the supply of the medication and to take steps to conserve the medication or determine a suitable substitution. The visualization may be or include adjusting one or more of icons, colors, or fonts presented to indicate supply status for a medication.

As described above, the inventory engine 110 may compare and/or allow for a comparison of the supply of medications across geographical regions. In some implementations, the inventory engine 110 allows for a comparison between a first medication inventory metric associated with a medication at a first medical facility located within a first geographical region and a second medication inventory metric associated with the medication at a second medical facility located within a second geographical region.

For example, the inventory engine 110 may generate a first medication inventory metric based on a first subset of inventory data (e.g., a first ordered quantity and a first delivered quantity) associated with the first medical facility. The first medication inventory metric may indicate a likelihood of an interruption in supply of the medication to the first medical facility.

The inventory engine 110 may also receive, from the medication inventory system, a second subset of medication inventory data including a second ordered quantity of the medication ordered to supply the second medical facility and a second received quantity of the medication delivered to the second medical facility). The inventory engine 110 may generate the second medication inventory metric based on the second subset of the medication inventory data. The second medication inventory metric may indicate a likelihood of an interruption in supply of the medication to the second medical facility.

The inventory engine 110 may compare the first medication inventory metric to the second medication inventory metric, and detect, based on the comparison, a trend in the likelihood of the interruption. The inventory engine 110 may cause display of the trend, such as in a report, a visualization, or the like. The trend may allow prescribers to quickly and proactively adjust prescribing practices.

In some implementations, the inventory engine 110 receives, from the medication inventory system 104, updated medication inventory data including another ordered quantity of the medication ordered to supply the medical facility and another received quantity of the medication delivered to the medical facility. The inventory engine 110 (e.g., based on receiving the updated medication inventory data), may adjust the medication inventory metric using one or more methods as described herein. The inventory engine 110 may display a graphical element on the display (e.g., via the client 250). The graphical element may indicate a change in the likelihood of the interruption in the supply of the medication to the medical facility. For example, the inventory engine 110 may determine that the likelihood of the interruption in the supply of the medication has decreased to an acceptable level. Additionally or alternatively, the inventory engine 110 may determine that the there is no longer a shortage of the medication. As a result, the inventory engine 110 may display the graphical element to alert the prescriber or clinician of the change in the likelihood of the interruption in the supply of the medication to the medical facility. This allows for the prescriber or clinician to quickly and proactively adjust prescribing or treating practices.

In some implementations, the inventory engine 110 may adjust a protocol for handling the medication based on the medication inventory metric. For example, if a medication is identified as having a significant likelihood of an interruption in the supply or as having a likely shortage, the price and/or demand of the medication may increase, making the medication more valuable for possible diverters. In some implementations, the inventory engine 110 may, as a result, adjust the workflow to manage and/or dispense the medication such as requiring a witness to dispense the medication, or adjusting the permission level needed to perform certain actions (e.g., dispense the medication).

As an example, the inventory engine 110 may detect a request to access a medication dispenser to retrieve the medication identified as having a supply interruption or shortage. The inventory engine 110 may then require, based on the adjusting, one or more of a witness during the access of the medication dispenser and an enhanced authentication or logging to access the medication from the medication dispenser. The enhanced authentication may include a passcode, a badge scan, an image recognition of the face of the requester, a thumbprint or other fingerprint scan, and/or the like. The adjustment of the protocol for handling the medication may reduce diversion of the medication, such as by enhancing the security of the medication and by making it more difficult for possible diverters to access the medication.

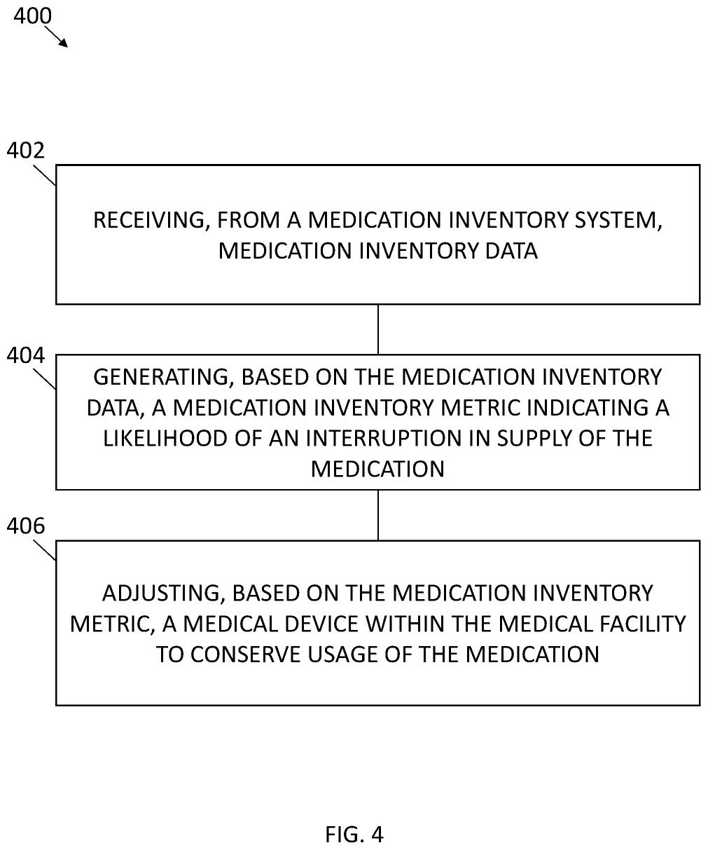

FIG. 4 depicts a flowchart illustrating a process 400 for conserving usage of a medication, in accordance with some example implementations. Referring to FIG. 4, the process 400 may be performed at least in part by the inventory engine 110 and/or the medication inventory management system 100.

At 402, the inventory engine 110 may receive, from a medication inventory system (e.g., the medication inventory system 104), medication inventory data. The medication inventory data may include an ordered quantity of a medication ordered to supply a medical facility and a received quantity of the medication at the medical facility. In some implementations, the medication inventory data is received after receipt of the received quantity at the medical facility. For example, the inventory engine 110 may detect storage of the received quantity at the medication inventory system. After detecting the storage of the received quantity at the medication inventory system, the inventory engine 110 may retrieve and process the medication inventory data.

At 404, the inventory engine 110 may generate, based on the medication inventory data, a medication inventory metric. The medication inventory metric may indicate a likelihood of an interruption in supply of the medication. The medication inventory metric may represent a confidence level that indicates the likelihood of the interruption in the supply of the medication to the medical facility.

In some implementations, the inventory engine 110 generates the medication inventory metric after detecting a measure of statistical significance as compared to the medication inventory data at the medication inventory system. Generating the medication based on a large quantity of medication inventory data improves the accuracy of the generated medication inventory metric.

In some implementations, the inventory engine 110 may generate the medication inventory metric by determining a difference between the ordered quantity and the delivered quantity. The inventory engine 110 may identify, based on the medication inventory metric, a shortage of the medication. For example, the inventory engine 110 may determine, based on the medication inventory metric corresponding to a threshold (e.g., a first threshold), the likelihood of the interruption in delivery of the medication is a significant likelihood. The inventory engine 110 may additionally or alternatively determine, based on the medication inventory metric corresponding to a second threshold, a shortage of the medication.

At 406, the inventory engine 110 may adjust, based on the medication inventory metric, a medical device within the medical facility to conserve usage of the medication.

For example, the inventory engine 110 may transmit an alert indicating the likelihood of the interruption in the supply of the medication to the medical facility. The alert may include one or more of a recommended action at a medication dispenser associated with the medical facility, a request for selection of an alternative medication that is different from the medication ordered at the medical facility, a display of an inventory level of the medication at the medical facility, a display of a historical usage of the medication at the medical facility, a display of an inventory level of the alternative medication at the medical facility, and a display of a second medication inventory metric associated with the alternative medication. The recommended action may include, for example, moving at least a portion of the medication stored at the medication dispenser to a second medication dispenser, such as where there is a greater clinical need. The clinical need may additionally or alternatively be determined by a clinician. Accordingly, the medication inventory management system 100 may help to conserve usage of medication that is indicated as having a high likelihood of an interruption in supply or as having a high likelihood of a shortage. The medication inventory management system 100 helps prescribers and clinicians to more quickly and proactively adjust the clinical and prescribing practices to better account for changes in medication supply and to better treat patients.

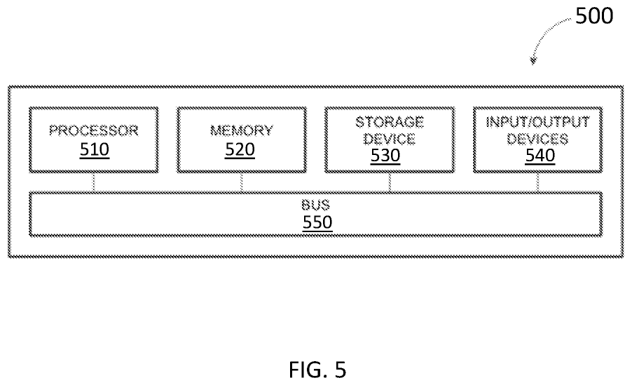

FIG. 5 depicts a block diagram illustrating a computing system 500 consistent with implementations of the current subject matter. Referring to FIGS. 1-4, the computing system 500 can be used to implement the medication inventory management system 100, such as the inventory engine 110, and/or any components therein.

As shown in FIG. 5, the computing system 500 can include a processor 510, a memory 520, a storage device 530, and input/output device 540. The processor 510, the memory 520, the storage device 530, and the input/output device 540 can be interconnected via a system bus 550. The processor 510 is capable of processing instructions for execution within the computing system 500. Such executed instructions can implement one or more components of, for example, the inventory engine 110 and/or the medication inventory management system 100. In some example implementations, the processor 510 can be a single-threaded processor. Alternatively, the processor 510 can be a multi-threaded processor. The processor 510 is capable of processing instructions stored in the memory 520 and/or on the storage device 530 to display graphical information for a user interface provided via the input/output device 540.

The memory 520 is a computer readable medium such as volatile or non-volatile that stores information within the computing system 500. The memory 520 can store data structures representing configuration object databases, for example. The storage device 530 is capable of providing persistent storage for the computing system 500. The storage device 530 can be a floppy disk device, a hard disk device, an optical disk device, a tape device, a solid-state device, and/or any other suitable persistent storage means. The input/output device 540 provides input/output operations for the computing system 500. In some example implementations, the input/output device 540 includes a keyboard and/or pointing device. In various implementations, the input/output device 540 includes a display unit for displaying graphical user interfaces.

According to some example implementations, the input/output device 540 can provide input/output operations for a network device. For example, the input/output device 540 can include Ethernet ports or other networking ports to communicate with one or more wired and/or wireless networks (e.g., a local area network (LAN), a wide area network (WAN), the Internet).

In some example implementations, the computing system 500 can be used to execute various interactive computer software applications that can be used for organization, analysis and/or storage of data in various formats. Alternatively, the computing system 500 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 540. The user interface can be generated and presented to a user by the computing system 500 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

As used herein, the term “message” encompasses a wide variety of formats for communicating (e.g., transmitting or receiving) information. A message may include a machine readable aggregation of information such as an XML document, fixed field message, comma separated message, JSON, a custom protocol, or the like. A message may, in some embodiments, include a signal utilized to transmit one or more representations of the information. While recited in the singular, it will be understood that a message may be composed, transmitted, stored, received, etc. in multiple parts.

As used herein, the terms “adjust” or “adjusting” or “control” or “controlling” encompass a wide variety of actions. For example, “adjusting” a device may include transmitting one or more messages to change an operational state or functional element of the device. The message may include specific instructions to be executed by a processor of the device to manifest the change. The “adjusting” may include storing a value in a location of a storage device for subsequent retrieval by the device to be controlled, transmitting a value directly to the device to be controlled via at least one wired or wireless communication medium, transmitting or storing a reference to a value, and the like. For example, a control message may include a value to adjust a level of power from a power source of the controlled device. As another example, a control message may activate or deactivate a structural element of the controlled device such as a light, audio playback, a motor, a lock, a pump, a dispensing cabinet, a dispensing drawer, a dispensing bin, a display, or other component of a device described herein. “Controlling” or “adjusting” may include indirect control of the device by adjusting a configuration value used by the controlled device. For example, the control message may include a threshold value for a device characteristic (e.g., temperature, rate, frequency, etc.). The threshold value may be stored in a memory location and referred to by the controlled device during operation.

As used herein, the terms “determine” or “determining” encompass a wide variety of actions. For example, “determining” may include calculating, computing, processing, deriving, generating, obtaining, looking up (e.g., looking up in a table, a database or another data structure), ascertaining and the like via a hardware element without user intervention. Also, “determining” may include receiving (e.g., receiving information), accessing (e.g., accessing data in a memory) and the like via a hardware element without user intervention. “Determining” may include resolving, selecting, choosing, establishing, and the like via a hardware element without user intervention.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A system, comprising:
at least one data processor; and
at least one memory storing instructions which, when executed by the at least one data processor, result in operations comprising:
receiving, from a medication inventory system, medication inventory data comprising an ordered quantity of a medication ordered to supply a medical facility and a received quantity of the medication delivered to the medical facility, wherein the medication inventory data is received after receipt of the received quantity by the medical facility;
generating, based on the medication inventory data, a medication inventory metric, wherein the medication inventory metric indicates a likelihood of an interruption in supply of the medication to the medical facility; and
adjusting, based on the medication inventory metric, a medical device within the medical facility to conserve usage of the medication.

2. (canceled)

3. The system of claim 1, wherein the adjusting comprises transmitting an alert indicating the likelihood of the interruption in the supply of the medication to the medical facility, and wherein the alert comprises one or more of a recommended action at a medication dispenser associated with the medical facility, a request for selection of an alternative medication that is different from the medication ordered at the medical facility, a display of an inventory level of the medication at the medical facility, a display of a historical usage of the medication at the medical facility, a display of an inventory level of the alternative medication at the medical facility, and a display of a second medication inventory metric associated with the alternative medication.

4. The system of claim 3, wherein the recommended action comprises moving at least a portion of the medication stored at the medication dispenser to a second medication dispenser.

5. The system of claim 4, wherein a second clinical need of the medication at the second medication dispenser is greater than a first clinical need of the medication at the medication dispenser.

6. The system of claim 5, wherein generating the inventory metric comprises determining a difference between the ordered quantity and the received quantity.

7. The system of claim 6, wherein the medication inventory metric is a confidence level that indicates the likelihood of the interruption in the supply of the medication to the medical facility.

8. The system of claim 7, wherein the operations further comprise determining, based on the medication inventory metric corresponding to a threshold, the likelihood of the interruption in supply of the medication is a significant likelihood.

9. The system of claim 8, wherein the operations further comprise determining, based on the medication inventory metric corresponding to a second threshold, a shortage of the medication.

10. The system of claim 9, wherein the operations further comprise detecting, prior to generating the medication inventory metric, a measure of statistical significance as compared to the medication inventory data at the medication inventory system; and wherein the generating is in response to the detecting.

11. The system of claim 10, wherein the operations further comprise: detecting receipt of the received quantity at the medication inventory system.

12. The system of claim 11, wherein the operations further comprise:
receiving, from the medication inventory system, updated medication inventory data comprising another ordered quantity of the medication ordered to supply the medical facility and another received quantity of the medication at the medical facility, wherein the updated medication inventory data is received after receipt of the another received quantity by the medical facility; and
adjusting, based on the updated medication inventory data, the medication inventory metric.

13. The system of claim 12, wherein the operations further comprise displaying, based on the adjusted medication inventory metric, a graphical element on a display, wherein the graphical element indicates a change in the likelihood of the interruption in the supply of the medication to the medical facility.

14. The system of claim 13, wherein the operations further comprise: adjusting, based on the medication inventory metric, a protocol for handling the medication identified as having a supply interruption or shortage.

15. The system of claim 14, wherein the operations further comprise:
detecting a request to access a medication dispenser to retrieve the medication identified as having a supply interruption or shortage; and
requiring, based on the adjusting, one or more of a witness during the access of the medication dispenser and an enhanced authentication or logging to access the medication from the medication dispenser.

16. The system of claim 15, wherein the operations further comprise: identifying, based on the medication inventory metric, a shortage of the medication.

17. (canceled)

18. The system of claim 1, wherein the medical facility is a first medical facility located in a first geographical region; wherein the medication inventory data is a first subset of the medication inventory data associated with the first medical facility; wherein the medication inventory metric is a first medication inventory metric that indicates a likelihood of an interruption in supply of the medication to the first medical facility; and wherein the operations further comprise:
receiving, from the medication inventory system, a second subset of the medication inventory data comprising a second ordered quantity of the medication ordered to supply a second medical facility located in a second geographical region and a second received quantity of the medication at the second medical facility, wherein the second subset of the medication inventory data is received after receipt of the second received quantity by the second medical facility; and
generating, based on the second subset of the medication inventory data, a second medication inventory metric, wherein the second medication inventory metric indicates a likelihood of an interruption in supply of the medication to the second medical facility.

19. (canceled)

20. The system of claim 1, wherein the operations further comprise comparing the first medication inventory metric to the second medication inventory metric, and wherein the operations further comprise detecting, based on the comparing, a trend in the likelihood of the interruption in supply of the medication.

21. A method, comprising:
receiving, from a medication inventory system, medication inventory data comprising an ordered quantity of a medication ordered to supply a medical facility and a received quantity of the medication at the medical facility, wherein the medication inventory data is received after receipt of received quantity by the medical facility;
generating, based on the medication inventory data, a medication inventory metric, wherein the medication inventory metric indicates a likelihood of an interruption in supply of the medication to the medical facility; and
adjusting, based on the medication inventory metric, a medical device within the medical facility to conserve usage of the medication.

22. The method of claim 21, wherein the adjusting comprises transmitting an alert indicating the likelihood of the interruption in the supply of the medication to the medical facility.

23. The method of claim 22, wherein the alert comprises one or more of a recommended action at a medication dispenser associated with the medical facility, a request for selection of an alternative medication that is different from the medication ordered at the medical facility, a display of an inventory level of the medication at the medical facility, a display of a historical usage of the medication at the medical facility, a display of an inventory level of the alternative medication at the medical facility, and a display of a second medication inventory metric associated with the alternative medication.

24-43. (canceled)
